(19) United States
(12) Patent Application Publication
(10) Pub. No.: US 2005/0178010 A1
(43) Pub. Date: Aug. 18, 2005

(54) Chainsaw tool

(76) Inventor: Alex Petrenko, Port Charlotte, FL (US)

Correspondence Address: RATNERPRESTIA, P.O. BOX 1596, WILMINGTON, DE, 19899, US

(21) Appl. No.: 11/040,392

(22) Filed: Jan. 21, 2005

Related U.S. Application Data
(60) Provisional application No. 60/538,572, filed on Jan. 23, 2004.

(51) Int. Cl. B27B 17/02; B23D 57/02

(52) U.S. Cl. 30/383

(57) ABSTRACT

A saw having a body, a continuous loop cutting chain, and a chain support extending from the body, the body comprising one or more handles, a motor, and a chain driver. The chain support comprises one or more chain support bars having one or more wheels mounted thereon, each wheel adapted to receive and guide a portion of the chain, at least one wheel of which is mounted at an end of the one or more support bars. The chain support may be pivotable to a desired angle within a range of angles relative to the body. An adjustable guide mechanism may enable setting a maximum distance that the saw blade is able to protrude through a workpiece.

### CROSS-REFERENCE TO RELATED APPLICATIONS

This invention claims priority of U.S. provisional patent application Ser. No. 60/538,572, filed Jan. 23, 2004, the contents of which are incorporated herein by reference.

### FIELD OF THE INVENTION

This invention relates to saws, and more particularly to a chainsaw tool.

### BACKGROUND OF THE INVENTION

Chain saws are well known in the art for use primarily for sawing down trees, but also may be used in construction work for sawing boards and the like. Chain saws provide great versatility and speed in cutting operations. One drawback of chainsaws is that the chain tends to turn in a rather wide radius at the end of the saw, thereby limiting the turning radius of the saw for cutting within interior holes in a workpiece. Chain saws are also typically configured such that the user must position the cutting portion of the saw directly in front of his or her body.

Angle grinders are also well known in the art and typically have a body platform as shown generally in U.S. Pat. No. 5,201,146, assigned to the Makita Corporation of Japan. This type of body platform allows a user to perform cuts on workpieces that may not be directly in front of his or her body. Angle grinders typically only have a circular cutting blade, however, limiting cutting operations to the radius of the circular blade.

It would be desirable, therefore, to provide a saw that overcomes some or all of the deficiencies of standard chain saws and angle grinders, while combining some or all of the advantages.

### SUMMARY OF THE INVENTION

One aspect of the invention comprises a saw having a body, a continuous loop cutting chain, and a chain support extending from the body, the body comprising one or more handles, a motor, and a chain driver. The chain support comprises one or more chain support bars having one or more wheels mounted thereon, each wheel adapted to receive and guide a portion of the chain, at least one wheel of which is mounted at an end of the one or more support bars.

The one or more chain support bars may extend from a swivel plate pivotably attached to the body and adapted to be fixed at a desired angle within a range of angles relative to the body. The one or more chain support bars may be attached to a chain tension adjusting mechanism mounted to the swivel plate and movable relative to the swivel plate to extend the one or more chain support bars inward or outward relative to the chain driver to increase or decrease tension on the cutting chain.

The saw may further comprise an adjustable guide mechanism for fixing a maximum distance that the saw blade is able to protrude through a workpiece. The adjustable guide mechanism comprises a movable plate for contact with a surface of the workpiece and that is movable relative to a fixed plate that is fixed relative to the central support bar; a brace for connecting the movable plate to the fixed plate; and an adjustment mechanism for manipulating the brace to set a desired distance between the movable plate and the fixed plate. The fixed plate may be mounted to the chain tension adjusting mechanism.

The one or more chain support bars may comprise an upper support bar and a lower support bar, in which the one or more wheels are mounted between the upper and lower support bars, or the one or more chain support bars may comprise only a single central support bar in which each of the one or more wheels comprises an upper portion and a lower portion between which the central support bar rests.

### BRIEF DESCRIPTION OF THE DRAWINGS

FIG. 1 is a perspective view of an exemplary saw of the present invention.

FIG. 2 is a cross-sectional view of the saw of FIG. 1 taken along lines 2-2.

FIG. 3A is an exploded perspective view of the exemplary saw of FIG. 1.

FIG. 3B is a perspective view of the underside of driving gear 30 shown in FIGS. 1 and 3A.

FIG. 4 is an exploded perspective underside view of selected components of the saw shown in FIG. 1, including the guide and chain-tightening mechanisms.

FIG. 5 is a cross-sectional view of the guide and chain tightening mechanisms of FIG. 4, taken across line 5-5 in FIG. 7.

FIG. 6 is a top view of an the guide mechanism in an expanded configuration.

FIG. 7 is a perspective view of the guide and chain tightening mechanisms of FIGS. 4-6 and the chain driving gear, with a portion of the chain, upper flange, and lock nut removed for purposes of the drawing.

FIG. 8 is a side view of a portion of the saw featuring the guide and chain tightening mechanisms with the chain removed.

FIG. 9 is a bottom view of the saw of FIG. 1 showing the adjustability of the blade relative to the body by illustrating a straight position in dashed lines and a pivoted position in solid lines.

FIG. 10 is an exploded perspective view of an alternate chain bar/wheel configuration.

FIG. 11 is a cross-sectional view of the chain bar/wheel configuration of FIG. 10.

FIG. 12 is a detailed view of the chain bar/wheel configuration shown in FIGS. 1-9.

FIG. 13 is a perspective view of an embodiment featuring the chain bar/wheel configuration of FIG. 10 and a number of safety features.

FIG. 14A is a detailed view of the hand guard shown in FIG. 13.

FIG. 14B is a perspective view of the chain guard shown in FIG. 13.

FIG. 15 is an exploded view showing the relationship between the chain guard and the chain bar of FIG. 13.

### DETAILED DESCRIPTION OF THE INVENTION

Referring now to the figures, there is shown an exemplary saw of the present invention comprising a body 10, which may comprise a body and motor that is essentially identical in construction to any commercially available angle grinder known in the art. The body may be any type or style, however, and may have beneficial features found on any type of construction tool. What is important, is that the body hold the sawblade and rotate the chain drive gear. The saw further comprises a chain support 12 having a plurality of wheels 18 along which chain 14 rides. Chain 14 may be of any chain-saw chain construction known in the art. Typically, body 10 includes a handle 11.

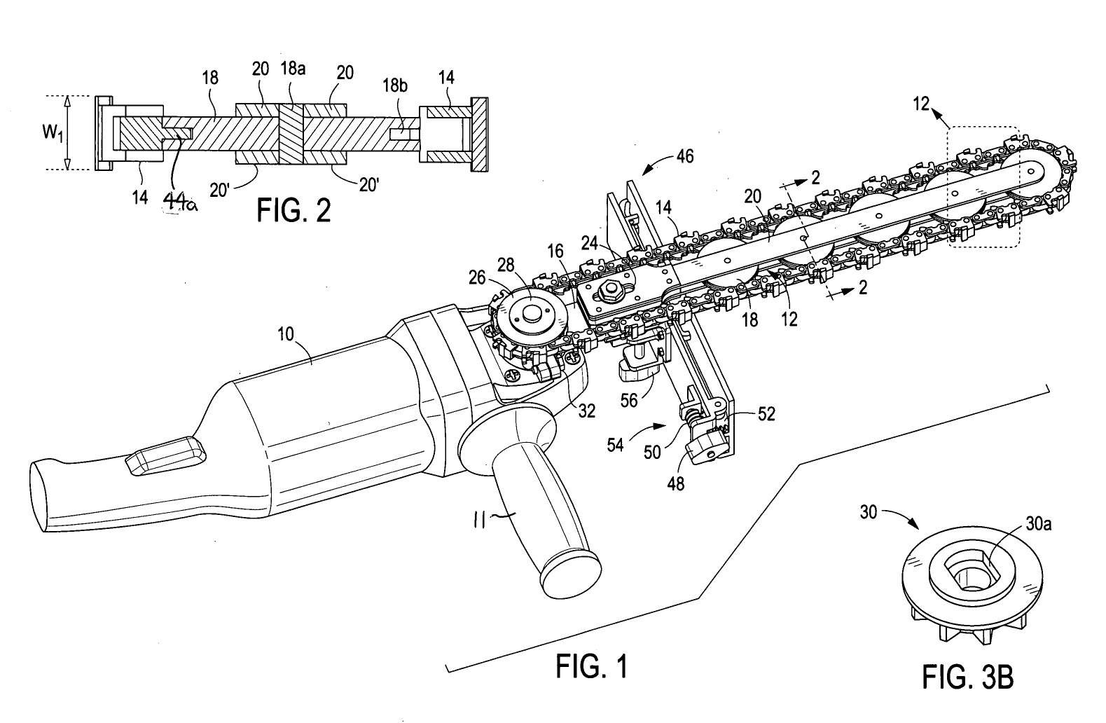

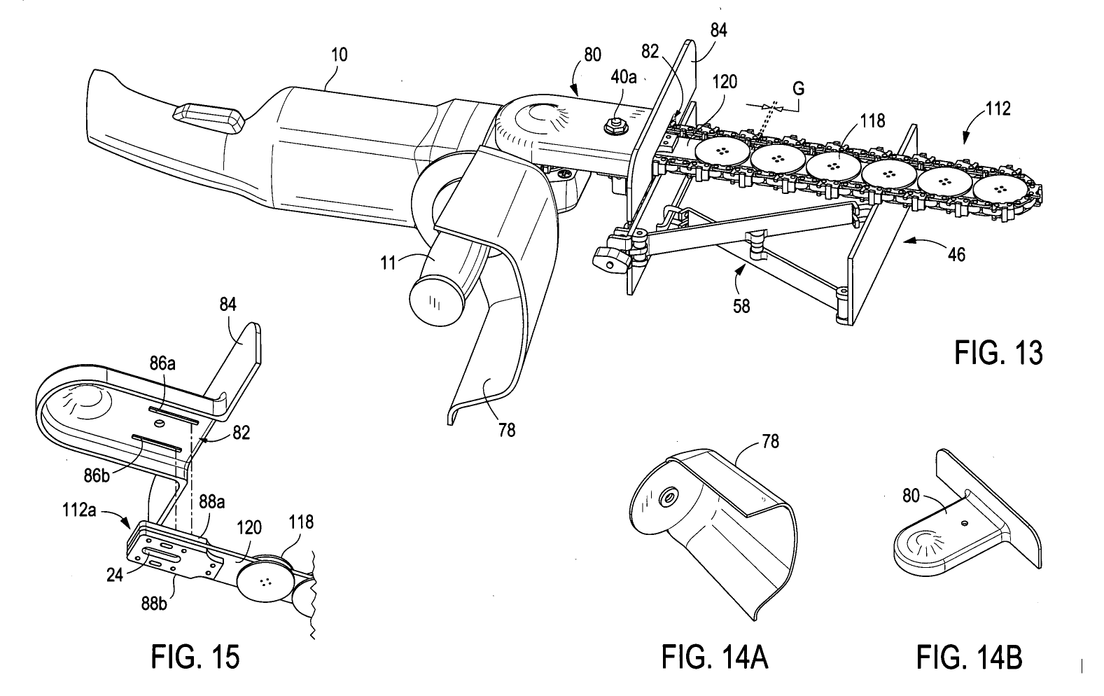

Although not shown in FIG. 1, to more easily view the details of the drawing, the saw may further comprise one or more safety guards for safety purposes, as is known in the art, to protect the user from the chain and to keep the chain from being thrown a great distance if the chain starts to come off of the saw. An exemplary set of safety guards is shown in FIGS. 13-15.

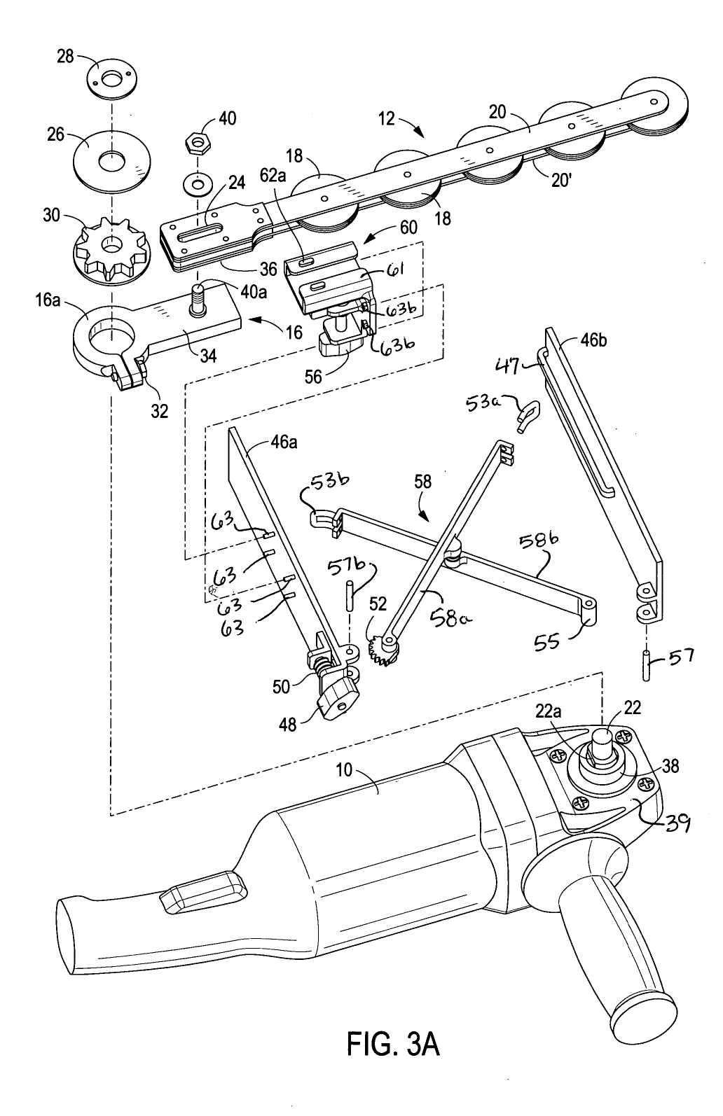

In the embodiment shown in FIGS. 1 and 2, chain support 12 comprises chain guide wheels 18 mounted on chain guide wheel axles 18a between identical upper and lower support arms 20 and 20′. Grooves 18b in the outer periphery of wheels 18 receive driver teeth 44a of chain 14. More detail of this embodiment is shown in FIG. 12, which shows the components of a standard chain 14 known in the art, including driver links 44 having driver teeth 44a for being driven by sprocket 30 (shown in FIG. 3A, for example) and for riding in chain wheel grooves 18b, and cutter links 42 comprising cutter teeth 42a for cutting the work surface. As the chain moves in direction A, the wheels rotate in direction B. The invention is not limited to any particular chain design.

In an alternate chain support embodiment 112, shown in FIGS. 10, 11, and 13, wheels 118 may be of a construction in which the wheels comprise an upper portion 118a and a lower portion 118b between which a central support arm 120 is positioned. Upper portion 118a may attach to lower portion 118b in any way known in the art, including but not limited to with screws 122 as shown in FIGS. 10 and 11. A ball-bearing mechanism 76 of any type known in the art may be mounted within opening 120a in arm 120 to allow for smooth rotation of wheels 118.

The use of wheels, as opposed to standard grooved chain support known in the art on chain saws, allows for less friction between the driver teeth and the chain support, and also allow for a tighter turning radius at the end of the chain support. Less friction may allow use of less lubrication oil on the chain. Although shown with wheels all along the distance of the chain support, one embodiment (not shown) may comprise just a single chain guide wheel at the end of the chain support, and a standard support bar having a grooved periphery for engaging the driver teeth along the length of the support bar between the drive sprocket 30 and the single chain guide wheel.

In the embodiment shown in FIGS. 1 and 2, width W1 of chain 14 must be wider than the overall distance from the outer surfaces of arms 20 and 20′, whereas in the embodiment shown in FIGS. 10 and 11, width W2 of chain 114 must be wider than the overall distance from the outer surfaces of upper portion 118a and lower portion 118b of wheels 118. It should be understood that although many of the figures depict the arm/wheel relationship shown in FIGS. 1 and 2, the relationship shown in FIGS. 10 and 11 may be used instead. It should also be noted that although the FIG. 1 shows a sizable space between adjacent wheels on the support arm or arms, the wheels may be closer together, such as the relatively minimal distance G shown in FIG. 13, in which the wheels almost touch one another, to minimize space over which the chain is unsupported between wheels.

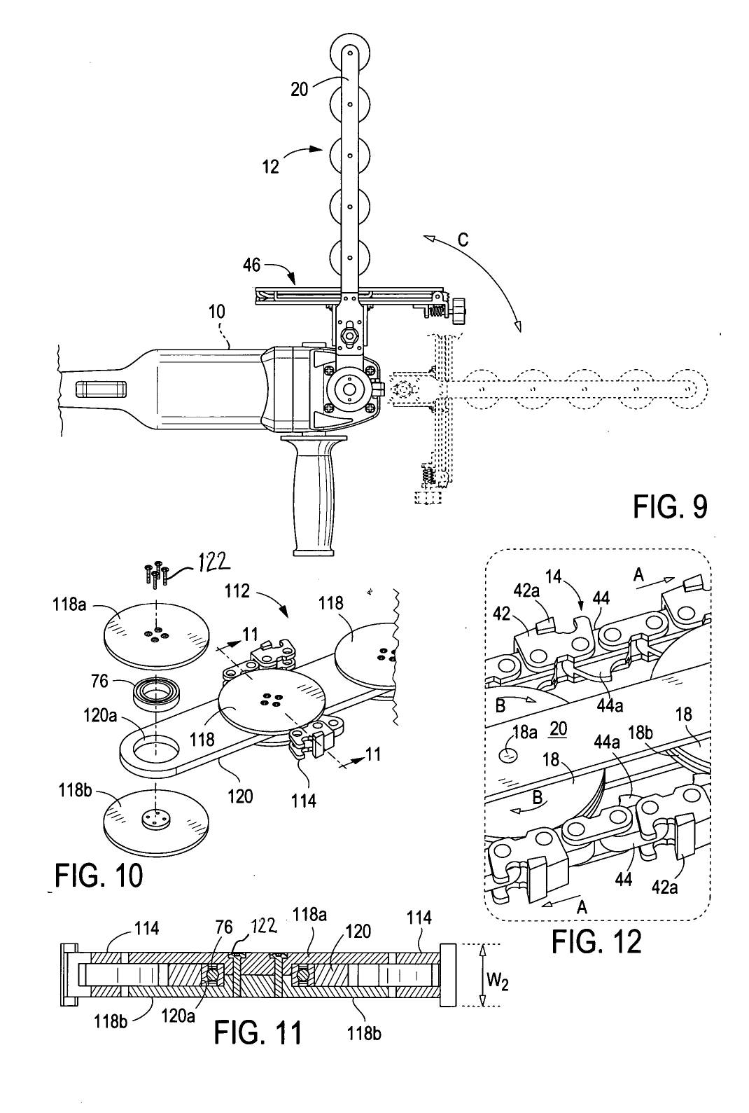

FIG. 3A shows the general relationship between the body 10, chain support 12, swivel plate 16, and the chain tightening and guide mechanism. Rounded portion 16a of swivel plate 16 fits over axle sleeve 38, which is a cylindrical protrusion of bearing cover 39. Swivel plate 16 comprises a screw/clamp mechanism 32 or other tightening means that allow the angle of the swivel plate relative to the body to be adjusted within the range of motion C shown in FIG. 9. When screw/clamp mechanism 32 is loosened, the swivel plate may be swiveled to a desired angle and then tightened to fix it in place. Although the swivel plate is a desirable feature, embodiments without such a swivel plate may also be provided, in which the relationship between the chain support and the body is fixed, for example, at the angle shown in FIG. 3A.

Chain 14 is driven by sprocket 30, the underside of which is shown in FIG. 3B. Sprocket 30 fits over axle 22, with non-round section 22a of the axle interfacing with non-round recess 30a in the drive gear. Chain 14 fits around sprocket 30, with upper flange 26 providing support for the chain as it goes around the sprocket, and lock nut 28 holding the assembly in place on the axle. The chain drive components are not limited to the design schematically shown here, however, and may be of any design known in the art for chain saw assemblies.

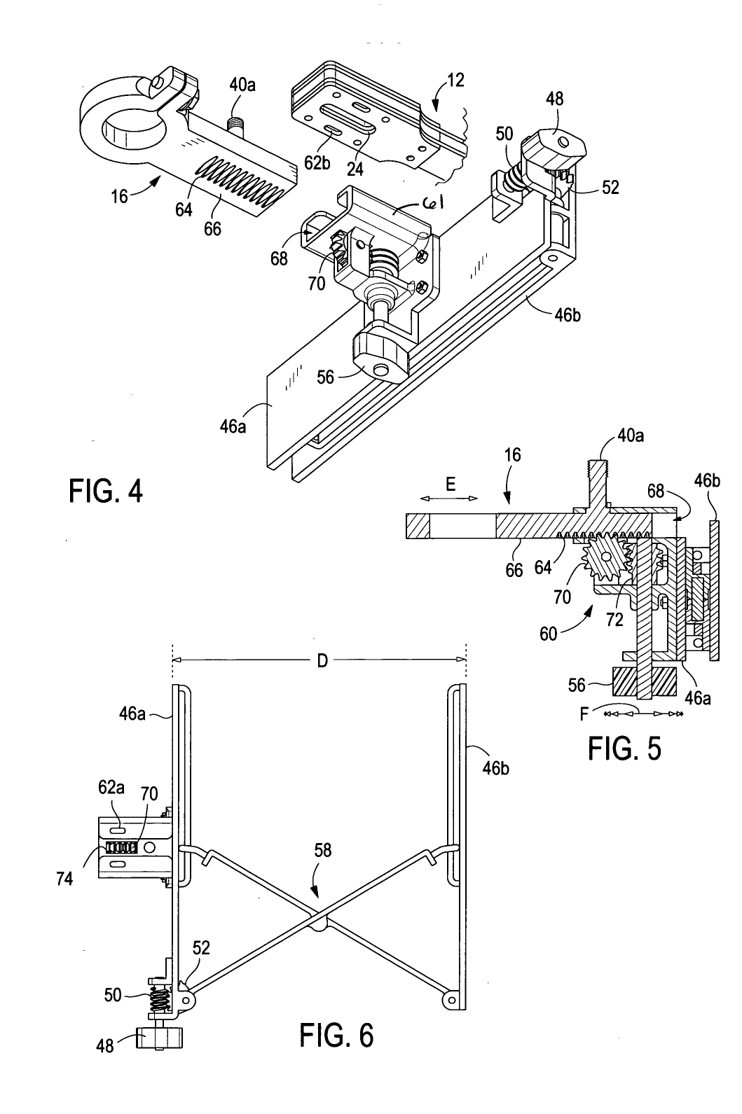

Mounting portion 36 of chain support 12 mounts on swivel plate 16 with post 40a mounted through slot 24 and with recesses 62b (shown in FIG. 4) aligned with protrusions 62a (shown in FIG. 3A) of chain tension adjusting mechanism 60. Body 61 of chain tension adjusting mechanism 60 comprises a C-shaped opening 68 for receiving swivel plate 16. Nut 40b holds down chain support 12 relative to body 61. With nut 40b in a relatively loose configuration, knob 56 may be turned, which rotates worm gear 72, which turns positioning gear 70, which protrudes through opening 74 in body 61. The teeth of positioning gear 70 engage indentations 64 in lower surface 66 of swivel plate 16 to move the chain support 12 in the direction of arrow E (shown in FIG. 5) to tighten or loosen the chain by changing the overall distance between the end of the support arm and chain driving gear 30. It should be understood, however, that myriad other types of chain adjustment mechanisms can be developed that perform the function of changing the distance between the end chain guide wheel on the chain support and chain drive sprocket 30, so the invention is not limited to any particular type of chain adjustment mechanism.

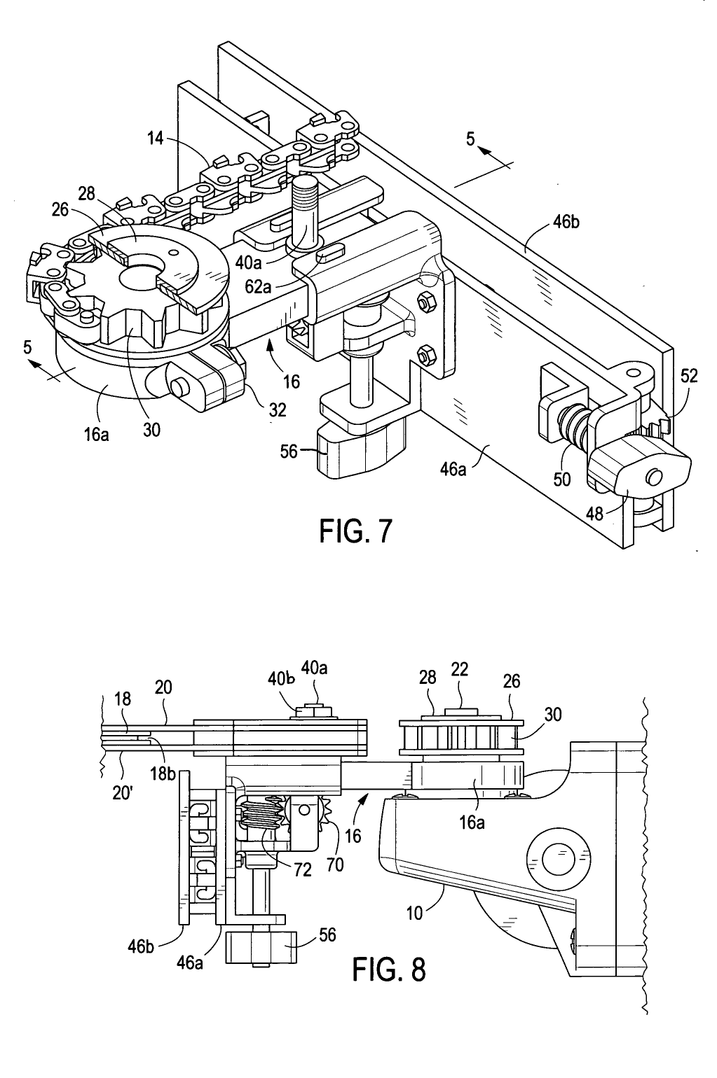

Mounted to the front of chain tension adjusting mechanism body 61 is optionally a guide mechanism 46, shown in more detail in FIGS. 6-8, capable of setting a maximum distance the saw blade will be allowed to protrude through a workpiece. Guide mechanism comprises a guide plate 46b that is movable relative to a support plate 46a. Support plate 46a may be attached to chain tension adjusting mechanism body 61 with mounting posts 63a, which may be threaded to receive fastening nuts 63b. The support plate may be referred to as being “essentially fixed” relative to the body. By this it is meant that the support plate is fixed relative to the body during the process of adjusting the movable guide plate position. As shown in this particular embodiment, the support plate is actually attached to the chain tension adjusting mechanism, so it is movable within the distance permitted by the chain during the chain tension adjusting process. Nonetheless, the position of the support plate relative to the body is fixed for a given chain of a given length at a given tension.

The distance D between the guide plate and the support plate, as shown in FIG. 6, is set by the position of X-brace 58 mounted between the two plates. X-brace 58 is manipulated by brace-adjusting mechanism 54, comprising knob 48, worm gear 50, and X-brace 58. X-brace 58 comprises a first member 58a comprising driving gear portion 52 and rail-engaging end 53a. Second member 58b comprises a pinned end 55, which is mounted to plate 46b with pin 57a, and a rail-engaging end 53b. The first member 58a and second member 58b are pivotably attached to one another, such as with a pin (not shown) that fits in recesses of both the members, or a pin in one member that fits into a corresponding hole (also not shown). Pin 57b mounts first member 58a to plate 46a. Each of plates 46a and 46b comprise a rail 47 which receives the respective rail-engaging end 53a or 53b to allow the rail-engaging end to slide relative to the plate 46a or 46b as the X-brace is expanded or contracted. Rotating knob 48 turns worm gear 50, which moves driving gear portion 52 of X-brace 58. The guide mechanism is not limited to the particular mechanism shown here, however, nor is the saw limited to having any such guide mechanism.

FIGS. 13-15 depict an embodiment comprising a plurality of safety features, each of which may also be present in the other embodiments shown herein, but omitted from the figures for clarity of the details discussion with respect to those figures. Hand guard 78 is provided around handle 11 to guard against a loose chain from kicking back and striking the user in the hand. Chain guard 80 is placed over the mounting portion 112a of chain support 112 to keep the chain from completely coming off of the chain support and being thrown when in use, and to further protect the user from the rapidly rotating chain by providing a guard surface 84 that is aligned in a plane parallel to the surface of guide 46. Chain support 112 comprises a single chain support arm 120, positioned between upper and lower reinforcing plates 88a and 88b, respectively, in mounting portion 112a. Chain guard 80 is fastened in place with nut 40a and comprises underside slide bars 86a and 86b, which are adapted to contact upper reinforcing plate 88a to reduce friction between the guard and the reinforcing plate as the chain support slides back and forth during adjustment. It should be understood that safety guards of any type may be provided, however.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

1. A saw comprising a body, a continuous loop cutting chain, and a chain support extending from the body, the body comprising one or more handles, a motor, and a chain driver, the chain support comprising:
one or more chain support bars having one or more chain guide wheels mounted thereon, each chain guide wheel adapted to receive and guide a portion of the chain, at least one chain guide wheel mounted at an end of the one or more chain support bars.

2. The saw of claim 1 further comprising a swivel plate pivotably attached to the body and from which the chain support extends, the swivel plate adapted to be fixed at a desired angle within a range of angles relative to the body.

3. The saw of claim 2 further comprising a chain tension adjusting mechanism slidably mounted on the swivel plate and on which the one or more chain support bars is attached, the chain tension adjusting mechanism movable relative to the swivel plate to extend the one or more chain support bars inward or outward relative to the chain driver to increase or decrease tension on the cutting chain.

4. The saw of claim 3, wherein the swivel plate has a length that extends away from the body and has a set of grooves perpendicular to the length, the chain tension adjusting mechanism comprising a traveler that rides upon the swivel plate and comprises a gear that engages the toothed portion of the swivel plate, the chain tension adjusting mechanism comprising a knob for turning the gear for moving the traveler inward or outward relative to the chain driver, the one or more chain support bars comprising a plurality of members for non-pivotable and non-slidable engagement with a portion of the traveler and a slot for slidable engagement with a connector that is adapted to be tightened to compressively hold the one or more chain support bars on the traveler and to hold the traveler in a desired position relative to the swivel plate.

5. The saw of claim 1 further comprising an adjustable guide mechanism for fixing a maximum distance that the saw blade is able to protrude through a workpiece, the adjustable guide mechanism comprising a movable guide plate for contact with a surface of the workpiece and an adjustment mechanism for positioning the movable plate a distance from the body within a range of possible distances.

6. The saw of claim 5, wherein the adjustable guide mechanism further comprises a support plate that is essentially fixed relative to the body and a brace for connecting the guide plate to the support plate, the adjustable guide mechanism adapted to move the brace to change a distance between the guide plate and the support plate.

7. The saw of claim 6, wherein the adjustable guide mechanism comprises an X-brace comprising two crossed members pinned to one another in a central location, a first member pivotably pinned at one end to the guide plate and slidably engaged at the opposite end to a rail mounted to the support plate, and a second member pivotably pinned at one end to the support plate and slidably engaged at the opposite end to a rail mounted to the guide plate, the first member comprising a mechanism for manipulating an angle of the first member relative to the support plate.

8. The saw of claim 7, wherein the first member comprises a semi-circular toothed portion adjacent the support plate and the mechanism for manipulating the angle of the first member relative to the support plate comprises a knob for rotating a worm gear that meshes with the semi-circular toothed portion such that rotation of the worm gear pivots the toothed portion to change the angle.

9. The saw of claim 6 further comprising:
a swivel plate pivotably attached to the body and from which the chain support bars extends, the swivel plate adapted to be fixed at a desired angle within a range of angles relative to the body; and
a chain tension adjusting mechanism mounted to the swivel plate and on which the chain support is attached, the chain tension adjusting mechanism movable relative to swivel plate to extend the chain support inward or outward relative to the chain driver to increase or decrease tension on the cutting chain;
wherein the support plate is mounted to the chain tension adjusting mechanism.

10. The saw of claim 1, wherein the one or more chain support bars comprises an upper support bar and a lower support bar, and the one or more wheels are mounted between the upper and lower support bars.

11. The saw of claim 1, wherein the one or more chain support bars comprises a central support bar and each of the one or more wheels comprises an upper portion and a lower portion between which the central support bar is positioned.

12. The saw of claim 1 further comprising one or more safety guards for preventing the chain from coming completely off of the chain support during use, for protecting a user's hand on a handle of the saw, or a combination thereof.

13. A saw comprising:
a body having one or more handles, a motor, and a chain driver that is driven by the motor;
a continuous loop cutting chain that is driven by the chain driver;
a swivel plate pivotably attached to the body, the swivel plate adapted to be fixed at a desired angle within a range of angles relative to the body;
a chain support extending from the body, the chain support comprising a chain support bar having one or more chain guide wheels mounted thereon, each chain guide wheel adapted to receive and guide a portion of the chain, each of the one or more chain guide wheels comprising an upper portion and a lower portion between which the support bar is positioned, at least one chain guide wheel mounted at an end of the support bar;
a chain tension adjusting mechanism mounted to the swivel plate and on which the chain support is attached, the chain tension adjusting mechanism slidably movable relative to the swivel plate to extend the chain support inward or outward relative to the chain driver to increase or decrease tension on the cutting chain;
an adjustable guide mechanism for fixing a maximum distance that the saw blade is able to protrude through a workpiece, the adjustable guide mechanism comprising a movable plate for contact with a surface of the workpiece and movable relative to the saw body and an adjustment mechanism for manipulating the movable plate to be positioned a desired distance from the saw body for manipulating the movable plate to be positioned a desired distance from the saw body for positioning the movable plate a distance from the body within a range of possible distances; and
one or more safety guards for preventing the chain from coming completely off of the chain support during use, for protecting a user's hand on a handle of the saw, or a combination thereof.

14. A saw comprising:
a body having one or more handles, a motor, and a chain driver that is driven by the motor;
a continuous loop cutting chain that is driven by the chain driver;
chain support means extending from the body for receiving and guiding the cutting chain, the chain support means comprising at least one chain guide wheel mounted at an end thereof;
chain tension adjusting means for increasing or decreasing tension on the cutting chain; and
safety guard means for preventing the chain from coming completely off of the chain support means during use, for protecting a user's hand on a handle of the saw, or a combination thereof.

15. The saw of claim 14, further comprising adjustable guide means for fixing a maximum distance that the saw blade is able to protrude through a workpiece, the adjustable guide means comprising a movable plate for contact with a surface of the workpiece that is movable within a range of possible distances from the saw body.

16. The saw of claim 14, further comprising swivel means on which the chain support is mounted, the swivel means pivotably attached to the body and adapted to be fixed at a desired angle within a range of angles relative to the body.
